(19) United States
(12) Patent Application Publication
(10) Pub. No.: US 2024/0383394 A1
(43) Pub. Date: Nov. 21, 2024

(54) COLLAPSIBLE HOPPER WITH DEFORMABLE EXTENSION

(71) Applicant: DESARROLLOS TECNOLOGICOS S.A., Santiago (CL)

(72) Inventors: Asdrúbal José AYESTARÁN DÍAZ, Santiago (CL); Francisco Javier AGUIRRE GRAPIN, Santiago (CL)

(21) Appl. No.: 18/259,312

(22) PCT Filed: Nov. 15, 2021
(86) PCT No.: PCT/CL2021/050111

§ 371 Date: Jun. 26, 2023

(30) Foreign Application Priority Data
Dec. 28, 2020 (CL) 3404-2020

(51) Int. Cl. B60P 1/28

(52) U.S. Cl. CPC B60P 1/283

(57) ABSTRACT

A Dump body for cargo vehicles, comprising: a non-uniform tail extension portion coupled to the rear of the Dump body tail; wherein the tail portion collapses by plastic deformation due to its structural configuration, being partially or entirely made of composite materials.

### FIELD OF THE INVENTION

The present invention relates to a mechanism for floors and sides, sideboards, walls and/or ducktail of a collapsible (plastically deformable) Dump body, so that, in the event of an impact by reaching the rear of the hopper, the protection of the operator and the adequate dissipation of energy is ensured. The mechanism can be used on any type of Dump body.

### DESCRIPTION OF THE PRIOR ART

The vast majority of conventional vehicles, from private cars to road trucks, including all types of urban and intercity buses, include in their design, a deformable front and rear bumper, as a safety element in the event of a collision between one or more vehicles. which allows to dissipate part of the energy of the impact, deforming plastically. Thus, in a rear-end collision between conventional vehicles, the first elements to be hit will be the bumpers, which will deform plastically, absorbing part of the impact energy and protecting the vehicle chassis, which is the main structure where all parts of the vehicle are mounted and in particular the cabin, where the driver and passengers are located, from receiving a direct impact from a structure of the other vehicle.

More particularly, in the field of mining truck operation today, there is always the possibility of a serious accident. A problem that can be fatal in most cases occurs when there is a collision of two or more mining trucks, even at very low speeds. When this happens, the tail of the Dump body may hit the cab of the truck colliding from behind, and deform the cab. This makes the tail particularly dangerous in the event of an impact since its effect will be similar to that of a guillotine that will initially deform and eventually cut, transversely, the cab pillars, seriously exposing the operator (as shown in FIG. 1). The same will happen to any structure that may collide with the Dump body tail.

In dump trucks for mining applications, due to the load capacity required for the trucks, the design of the Dump body is optimized, compensating the load distribution between axles. Consequently, the length of the hopper exceeds the rear tires of the truck, leaving the rear of the truck exposed, with no additional protective elements to prevent damage from blows, collisions, or crashes, either sideways or from the rear. On the other hand, the design of the front of the truck, positions the operator's cab in front of the vertical axis of the front tire, which also leaves it exposed to being hit by the tail of a Dump body in the event of a rear-end collision.

To solve this problem, there are several suppliers of structures on the market today, which vary in design and achieve the objective of lengthening the front of the truck so that, in the event of a rear-end collision with the rear of another truck (as shown in FIG. 3), the bumper hits the rear tires of the truck and prevents the Dump body tail from hitting the cab. These steel structures can weigh up to 3 tons, depending on their size and the model of the truck on which they are installed. This weight is added to the truck's total weight, reducing its load capacity by an amount equal to its weight, since the truck has a maximum authorized gross weight that cannot be exceeded.

The installation of this bumper has an impact on the truck's operational performance, since it increases fuel consumption costs and reduces the truck's operational capacity by reducing its load capacity by an amount equal to the weight of the structure.

Furthermore, depending on the design, this type of bumper does not always fulfill its function as an energy dissipator in case of impact, since its structure is not designed to deform plastically, working only as a distance barrier between the trucks in case of impact, and the physical integrity of the operator can also be affected since it has to absorb all the energy of the impact.

Additionally, this bumper extension, apart from what is indicated in the previous paragraph and, depending on the different types of trucks operating in the mines, generates operational problems from the point of view of the turning radius of the truck in the loading shaft, or in the ascending or descending curves of the mining route, mainly in those projects whose internal routes were designed without considering this device that lengthens the truck.

To better understand the problem involved, it should be considered that Dump bodies are generally made of steel and are structurally rigid. Therefore, they dissipate negligible energy in the event of a reaching impact (the deformation coefficient is very low), which generates a risk for the truck operator's safety if it hits the operator's cab.

On the other hand, the operator's cabs currently in use comply with FOPS and ROPS standards, which aim to protect the operator from impacts on the cab, as well as side impacts caused by rollovers.

Regarding rollovers, a rollover protection system (ROPS) is a system or structure intended to protect equipment operators and drivers from injuries caused by vehicle rollovers or overturns.

Like roll cages and roll bars on cars and trucks, a ROPS includes bars attached to the frame that maintain a space for the operator's body in the event of a rollover.

ROPS structures are commonly found on heavy equipment, tractors and earthmoving machinery used in construction, agriculture and mining, which are defined by various regulatory agencies, including Occupational Health and Safety regulations. The regulations include both a strength requirement and an energy absorption requirement for the structure. Some dump trucks have an extension to their Dump bodies, commonly called a visor, which covers the operator's compartment for ROPS purposes.

ROPS systems are commonly fitted to 4×4 vehicles, pickup trucks, earthmoving equipment, soil compactors and utility vehicles. Products such as these were developed so that employees moving around or into mines would receive additional protection in the event of a fleet vehicle rollover.

In the United States, ROPS designs have to be certified by a Professional Engineer, which will typically require destructive testing. The structure will be tested at a reduced temperature (where the metal is more brittle), or fabricated from materials that perform more satisfactorily at low temperatures.

In Australia and most other countries, the International Standards Organization has guidelines for destructively testing ROPS structures on excavators, forestry equipment and tractors. Theoretical performance analysis of new ROPS designs is not permitted as an alternative to physical testing.

FOPS stand for “Fallen Objects Protection System”. It is a system composed of a structure to protect against the eventual fall of objects, such as rocks, trees or material, during mining or construction work.

In spite of the above, although in many cases the designs comply with FOPS and ROPS standards, in reality, these are not sufficient to withstand the impact of the tail of a Dump body when it exceeds, for example, 10 km/hr and is loaded to full capacity (as shown in FIG. 5).

An example, in line with the above described, can be seen in publication CN 207241826, which discloses an operator's cab, which performs the function of deforming in the event of accidents.

Although it is specifically oriented to articulated dump Another example of the prior art, related to the problem, is in US 2015/0298741, which deals with an energy absorption structure, which can be placed at the front of the vehicle, as well as at the rear. The document proposes to install a lower structure, which is attached to a rail, and which deforms downward in the event of a crash, when an initiator is activated, causing the outward end of the vehicle to disengage, while the inward end remains attached to the vehicle. In this way, a deformable structure is provided, which is attached to the vehicle.

On the other hand, U.S. Pat. No. 6,308,809 shows a crash attenuation system comprising thin tubes configured to collapse in a controlled manner to absorb forces from a colliding vehicle. A frame can be used to add to various parts of a vehicle, such as a truck guardrail, bumper, etc. It is important to note that this system is oriented to attenuate the collision but is not oriented to protect the operator, but rather the vehicle.

Publication U.S. Pat. No. 6,244,637 describes a crash attenuator, located on the rear of a truck, which is mounted on the rear of a truck by means of a structure, and includes a frame, which supports an impact face, which is directed away from the truck. The frame further includes absorption elements. Again, this document is oriented to attenuate the crash, but it is not oriented to protect the operator, but rather the vehicle.

Therefore, it has been observed that there is a need to, among other things, protect the operator's cab of a cargo vehicle from an impact against the rear of another cargo vehicle, absorbing the impact energy and thus avoiding severe damage to the vehicle and operator.

### SUMMARY OF THE INVENTION

In the event of a rear-end impact on the rear of the <dump body of a truck, the operator's cab of the colliding truck may suffer severe structural damage due to the natural projection of the Dump body tail, increasing significantly the risk to the physical integrity of the operator, which may cause partial injuries (contusions, fractures, etc.) or a fatal accident.

In order to mitigate accidents and eliminate the possibility of a fatality, we propose the incorporation of extensions, particularly a floor and side segment, which can be perpendicular to the truck axis. These extensions are plastically deformable under longitudinal stresses in the Dump body of such a magnitude that they exceed the yield stress of the segment. Consequently, they contract, reducing the overall length of the Dump body.

Longitudinal stresses can be caused either by the impact on the rear of the Dump body by reaching or by hitting an obstacle against the Dump body.

### BRIEF DESCRIPTION OF THE FIGURES

FIG. 1 shows a side view of a crash event, which could result in the death of personnel in the cab.

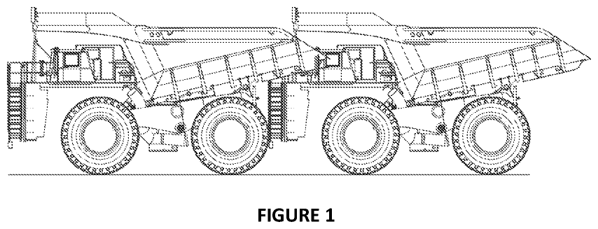

FIG. 2 shows a close-up view of the crash event, as shown in FIG. 1, emphasizing the Dump body tail projection over the cab.

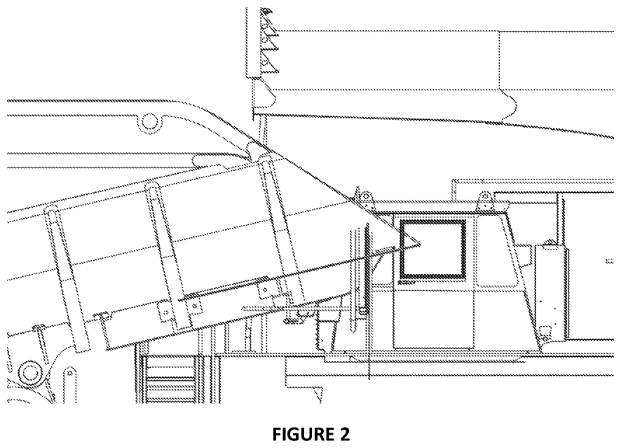

FIG. 3 shows a side view of a crash event, using a bumper solution of the prior art.

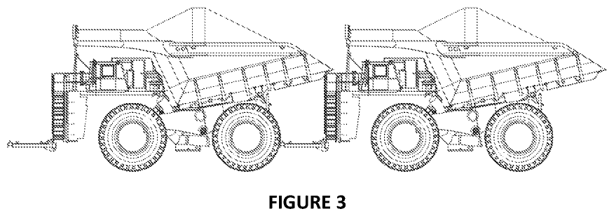

FIG. 4 shows a close-up view of the prior art solution, as shown in FIG. 3.

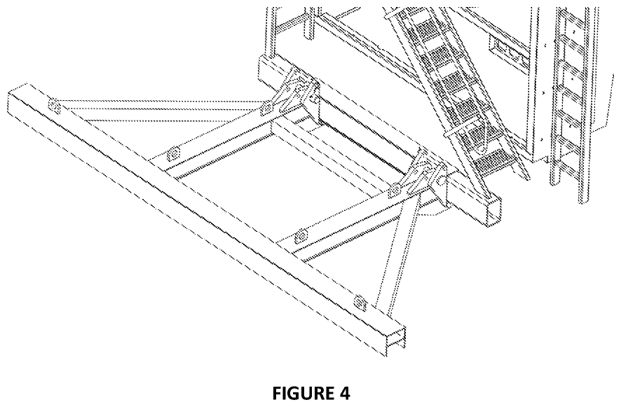

FIG. 5 shows a view of a crash event, similar to FIG. 1, but with a truck at full capacity.

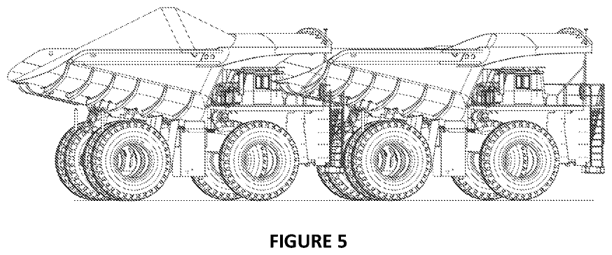

FIG. 6 shows a perspective view, as shown in FIG. 6.

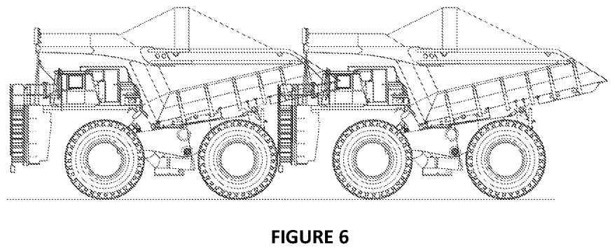

FIG. 7 shows a close-up view of the crash event, as shown in FIG. 5.

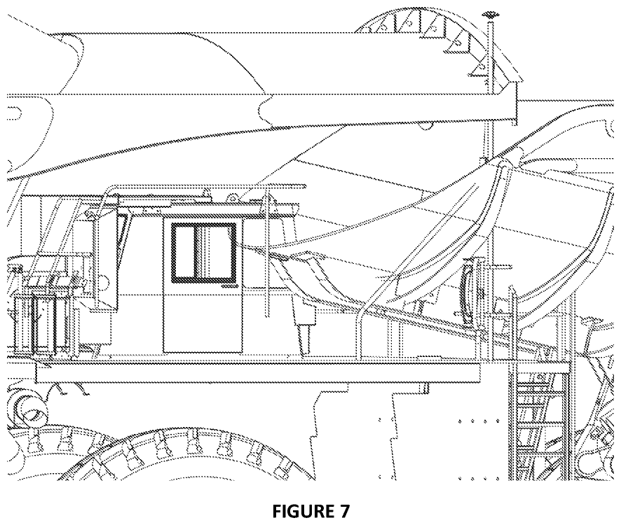

### DETAILED DESCRIPTION OF THE INVENTION

Given the above and, in order to eliminate the risk of a serious accident described above for the operator and to avoid, the design of a Dump body is presented whose rear tail section and sides can collapse, by plastic deformation, due to its structural configuration, combining in its entirety, composite materials, such as carbon fiber, fiberglass and ceramic rubbers, with low and high strength steels. The system to be implemented is passive and will not depend on electronic systems or additional electromechanical and/or hydraulic devices to fulfill its function, and its function will be to incorporate a rear bumper on the truck.

The design of the mining Dump body with a collapsible tail and sides (the collapsible system will be referred to as the tail and sides), has the following advantages:
SAFETY AND PROTECTION OF THE OPERATOR OF THE TRUCK THAT COLLIDES BY REACH WITH A DUMP BODY TRUCK: It guarantees the necessary deformation to absorb the energy of the impact, by reach, with another truck, minimizing the collapse of the structure that conforms the operator's cabin that, will be hit by the tail of the Dump body and in no case will allow its front pillars to fracture. The tail and collapsible sides shall be coupled to and form an integral part of the Dump body floor and sides. The system shall not have components or elements that, in the event of a collision, release material that could pose a risk to the truck operator or third parties, guaranteeing a stable and controlled deformation during the impact event, and reducing the maximum force transmitted to the operator's cabin.
FUNCTIONALITY: The Dump body with a collapsible tail and sides meets the typical loading and unloading operational requirements expected for a mining truck with the same load capacity as a non-collapsible Dump body. The composite structure must meet the extreme loading conditions required by the operation, according to the mining design, in order not to affect the expected loading volume.
OPERATIONAL CONTINUITY: The design of the collapsible Dump body ensures the operational continuity of the truck even if the Dump body collapses due to a collision at its rear. The design takes into account that part of the load deposited in the tail will spill onto the rear of the truck due to the plastic deformation of the Dump body, reducing its total length behind the rear tires without interfering with normal rolling or affecting traction capacity. This allows the equipment to continue operating normally so that it can independently make its way to the service workshop to repair the collapsed Dump body segment.
MAINTENANCE AND REPAIRABILITY: The system is built to withstand the operating conditions of the complete Dump body, so the preventive maintenance requirements are the same as those required for the rest of the Dump bodies. It is also modularly manufactured so that the tail and sides can be easily replaced without the need to disassemble the Dump body from the truck in the event of a collision, reducing the truck's stopping time.
UNIVERSALITY: The collapsible tail and sidewalls can be manufactured for any model of Dump body, regardless of the size, shape, capacity and materials used in its original manufacture. Therefore, the product is universally applicable to all existing Dump body models. Depending on the load capacity of the Dump body and its design, the geometry of the collapsible elements will vary, in order to always meet all the above requirements.

In addition, the collapsible system can be installed at any time on used Dump bodies in good conditions or during Dump body repair. Customers may purchase the collapsible system and install it on their Dump bodies whenever they choose, without restrictions. Specifically, the present invention provides a Dump Body for a cargo vehicle, comprising:
a non-uniform tail extension portion, coupled to the rear of the Dump body tail;
wherein the tail portion collapses by plastic deformation due to its structural configuration, such that it is made partially or wholly of composite materials.

In one modality, the composite material of the tail portion is chosen from a group comprising: carbon fiber, glass fiber and ceramic rubbers, with low and high-strength steels.

In another modality, the Dump body further comprises a non-uniform sidewall extension portion coupled to the rear of each sidewall of the Dump body, wherein the sidewall portion collapses by plastic deformation due to its structural configuration, such that it is made partially or entirely of composite materials.

Optionally, the composite material of the sidewall portion is chosen from a group comprising: carbon fiber, glass fiber and ceramic rubbers, with low and high-strength steels.

Anyone skilled in the art will note that multiple variations of the present invention can be realized, and that the detailed modalities are only an exemplification of the foregoing.

Dimensions and materials can be varied. Other forms resulting in the same inventive concept would also be possible.

1. A dump body for a cargo vehicle, wherein:
the rear part of the dump body tail comprises a non-uniform tail extension portion, wherein the non-uniform tail extension portion is integral with respect to the dump body tail;
wherein the tail portion collapses by plastic deformation due to its structural configuration, such that it is partially or wholly made of composite materials.

2. A dump body according to claim 1, wherein the composite material of the tail portion is chosen from a group comprising: carbon fiber, glass fiber and ceramic rubbers, with low and high-strength steels.

3. A dump body according to claim 1, wherein the rear portion of each dump body sidewall comprises a non-uniform sidewall extension portion, wherein the non-uniform sidewall extension portion is integral with respect to the rear portion of each dump body sidewall, wherein the sidewall portion collapses by plastic deformation due to its structural configuration, such that it is partially or wholly made of composite materials.

4. A dump body according to claim 3, wherein the composite material of the sidewall portion is chosen from a group comprising: carbon fiber, glass fiber and ceramic rubbers, with low and high-strength steels.
